(19) United States
(12) Patent Application Publication
(10) Pub. No.: US 2010/0019452 A1
(43) Pub. Date: Jan. 28, 2010

(54) Commodity Board Game

(76) Inventors: Michelle Ann Woestman, Phoenix, AZ (US); Jacqueline Ann Woestman, Milwaukee, WI (US); Julie Marie Woestman, Milwaukee, WI (US); Michael Anthony Woestman, Trempealeau, WI (US); Bernice Woestman, Trempealeau, WI (US)

Correspondence Address: THE LUTHER LAW FIRM, PLC, 10575 N 114TH STREET, SUITE 103, SCOTTSDALE, AZ, 85259, US

(21) Appl. No.: 12/180,458

(22) Filed: Jul. 25, 2008

(51) Int. Cl. A63F 3/00; G09B 19/22

(52) U.S. Cl. 273/256; 434/129

(57) ABSTRACT

A commodity board game teaches reducing risk by accumulating indicators that support the direction of the trade. The more indicators accumulated to support a trade, the less risk the player has in making a profit, which is similar to real-life commodity trading. The board game includes a board with a peripheral track marked with spaces for beginning, indicators, advice/payments, entry into contracts, exit techniques, contract, rest or marathon for charity and vacation; a board center; and a plurality of places for cards to be drawn, comprising entry, contract, indicator and advice/payments; a plurality of types of cards that include entry cards that represent the entry technique and expected market movement; indicator cards comprising a plurality of different groups, but all showing an up or down arrow and a representation for significance weighting; and advice/payment cards comprising teachings and market news, the teachings involving receipt or payment of money and market news affecting any player in a trade; at least two numbered dice; a market die comprising six faces, each indicating a different market; a plurality of game pieces for marking a player's progress around the board; a plurality of protective stop chips for a player to lessen a loss; a billboard plaque showing the standard amounts for trades in the different commodities and the parameters for ending trades; a plurality of money of different amounts; and instructions on how to play the game.

### TECHNICAL FIELD

This invention relates generally to an educational game and specifically to a board game teaching methods of reducing risk in commodities trading.

### BACKGROUND

There have been several games involving commodities. All the games revolve around the employment of chance for selecting when to buy, when to sell, how much to pay and how much to receive. None of these games require the accumulation of important advice or market indicators to effect buying the commodity. Such a game would improve the skill of the player at not only the game and but also in the real world commodities market.

### SUMMARY OF INVENTION

A commodity board game teaches reducing risk by accumulating indicators that support the direction of the trade. The more indicators that support a trade, the less risk in making a profit, just as in real life commodity trading. The board game includes a board with a peripheral track marked with spaces for beginning, indicators, advice/payments, entry into contracts, exit techniques, contract, rest or marathon for charity and vacation; a board center; and a plurality of places for cards to be drawn, comprising entry, contract, indicator and advice/payments; a plurality of types of cards that include entry cards that represent the entry technique and expected market movement; indicator cards comprising a plurality of different groups, but all showing an up or down arrow and a representation for significance weighting; and advice/payment cards comprising teachings and market news, the teachings involving receipt or payment of money and market news affecting any player in a trade; at least two numbered dice; a market die comprising six faces, each indicating a different market; a plurality of game pieces for marking a player's progress around the board; a plurality of protective stop chips for a player to lessen a loss; a billboard plaque showing the standard amounts for trades in the different commodities and the parameters for ending trades; a plurality of money of different amounts; and instructions on how to play the game.

In another embodiment, there is provided a method of playing a game of commodities trading. This method includes a) providing the above-described board game; b) preparing to play the game by the steps of i) placing the game board on a flat surface; ii) shuffling the four piles of cards, comprising indicator, entry technique, advice/payments, and contract cards; iii) selecting a game piece for each player and obtaining one protective stop chip and optionally five contract chips of the same color; iv) optionally giving each player three indicator cards and two entry cards; v) selecting a player as the banker to conduct all transactions; and vi) giving each player a plurality of money; b) beginning the game with the steps of i) placing all game pieces on the opening bell space; ii) selecting the first player to start, optionally by taking turns shaking and rolling a single die to select the first player with the highest score; iii) rolling two dice and moving the game piece the number of spaced indicated on the dice; iv) following the directions on the game board space; and v) letting the subsequent player(s) take turns; c) playing the game with the steps of i) landing on an entry/indicator space and choosing one or the other; ii) if choosing the entry, selecting an entry card; iii) if choosing the indicator, selecting an indicator card; iv) accumulating entry and/or indicator cards until deciding to buy a commodity; v) landing on an advice/payment space and picking up an advice/payment card and following the directions; vi) landing on the vacation space with the results comprising 1) losing two turns if in a trade; or 2) if not in a trade, moving to the next space with a choice between an indicator or an entry; vii) landing on the Marathon for Charity space and collecting money in the board center if available; d) making a trade in commodities with the steps of i) accumulating cards comprising 1) at least two indicator cards having the arrows in the same direction and being of different groups; 2) at least one entry card with an arrow in the same direction as the indicator cards; ii) landing on an entry space; iii) adding the weights of the indicator cards; iv) obtaining and rolling the market die to determine the market in which to make the trade; v) determining the cost of the trade from a graph showing the cost of the margin money and optionally the protective stop and whether the player has enough money for the trade and if not, re-rolling the die until selecting a market the player can afford; vi) if having enough money for the contract, determining if the player can enter multiple contracts, each requiring a contract chip if used; vii) putting the money, contract chips and optionally the stop in one stack on the board; viii) calculating the expected profit by multiplying the margin money by the number of contracts; and ix) turning the cards of the trade toward the board; e) closing a trade in commodities comprising the steps of i) landing on or passing over an exit space and determining a weighting value thereof; ii) rolling a plurality of dice; iii) calculating the dice total; iv) determining if the dice total is equal or greater than a target number, the target number being less when the player has more indicators in the trade and the target number being more when the player has fewer indicators in the trade, thereby providing less risk when there are more indicators supporting the trade; v) if the dice total is less than the target number and if the protective stop was used, paying to the bank the amount of the protective stop money; vi) if the dice total is less than the target number and if no protective stop was used, multiplying the expected profit by the weight of the exit space to determine total loss on the trade and paying to the bank the total loss; vii) if the dice total is equal to or greater than the target number, 1) multiplying the expected profit by the weight of the exit space to determine total profit on the trade; and 2) having the bank pay the total profit; and viii) placing the indicator and entry cards under their respective card stacks on the board.

### BRIEF DESCRIPTION OF THE DRAWINGS

FIG. 1 is a view of the board for use in the board game.

FIG. 2 is a plan view of a stack representing a trade with an adjacent toolbox.

FIG. 3 displays the anatomy of an entry card with the name of the entry technique, an illustration of the technique and the expected market movement based on the activity.

FIG. 4 displays the anatomy of an indicator card, entitled with the indicator group, the current activity within the specific indicator group, an illustration representing the activity, arrows for the expected market direction based on that activity, and central bars with the dark bars representing for card's weight (ranging from zero to four).

FIG. 5 displays examples of Squawk Box cards.

FIG. 6 displays examples of Contract cards.

FIG. 7 is a separate billboard plaque that can be placed on the board during the game. It has rows for each commodity and columns for the number of trades (1 to 5), as well as right-hand columns for the trade's indicator total and for the required minimum target for a winning trade. Clearly the higher the indicator total (sum of indicia of favorable indicators), the less luck is needed in the roll of the die.

FIG. 8 shows a tally card, on which each player tracks the buys and sells and maintains a running total.

FIG. 9 shows a billboard plaque for a high-value embodiment of the game, whose goal is achievement of a million dollars.

FIG. 10 is an expanded tally card, on which a player tracks buys and sells and maintains a running total.

FIG. 11 illustrates special contract card examples for a high-value embodiment of the game.

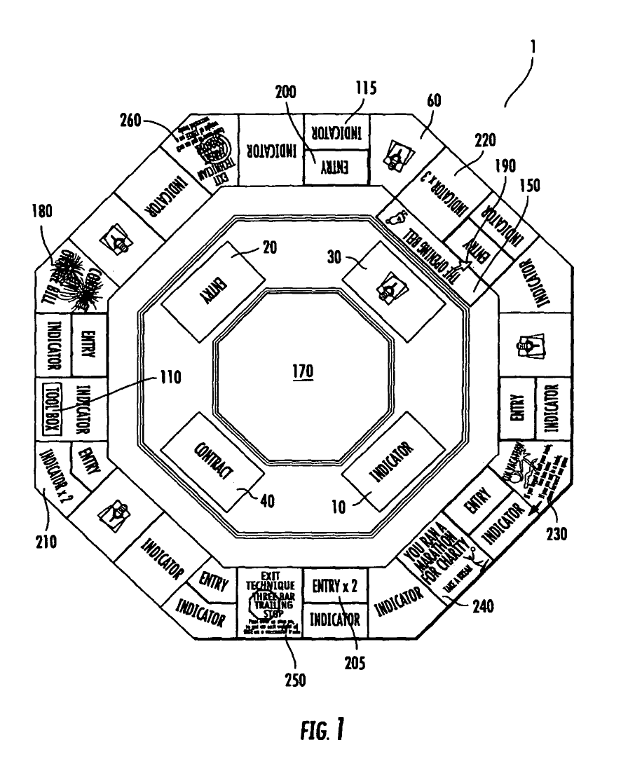

In the following detailed description of the preferred embodiments, reference is made to the accompanying drawings that form a part hereof, and in which are shown by way of illustrating specific embodiments in which the invention may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of present inventions. The following detailed description, therefore, is not to be taken in a limiting sense, and the scope of various embodiments of the invention is defined only by the appended claims, along with the full range of equivalents to which such claims are entitled.

### DETAILED DESCRIPTION

The current invention incorporates unique features which offer benefits to those who want to play a game and simultaneously learn important precepts in commodities trading.

The objectives of the game are enjoyment, as well as learning to trade commodities. The game introduces those who are intimidated by commodity trading to the terms and concepts in a safe learning environment. In addition, it introduces players to key elements of successful systems of trading commodities that help players better understand market trends and important factors to consider before making a trade. These elements are embodied in the board and cards. The inventors have creatively arranged the trading method, board and cards to teach players how to reduce risk and to be more successful in commodity trading. The player who has the largest trading account (Running Balance) upon the completion of five trades, wins. Table 1 lists the items included in the game box.

TABLE 1

| Item | Quantity |
|---|---|
| Game Board | 1 |
| Six-Sided Dice | 3 |
| Market Die | 1 |
| Toolbox | 1 |
| Cardholders | 4 |
| Protective Stop Chips | 4 |
| Various Color Contract Chips | 20 |
| (optional) | |
| Game Pieces | 4 |
| Billboard Plaque | 1 |
| Tally Cards | Many |
| Instructions | 1 |
| Pencils | 4 |
| Money | Many |
| Money Holder | 1 |

A variety of other equipment can be optionally used and includes calculators. Additional parts are provided with a high-value embodiment that follows the general description. When a color is mentioned, the color is only used for convenience and may be freely substituted.

### General Description

### Pre-Game Preparation

1. Place the board 1 on a flat surface where all players can easily reach it.

2. Shuffle the Indicator 140, Entry Technique 120, Squawk Box 35, and Contract cards 45. Place them face down on their designated spaces on the board 1.

3. Each player chooses one pawn to represent him or her while traveling around the board 1. The player then takes five of the corresponding color chips 80 and one red protective stop chip 90.

4. Each player takes one plastic card holder, blank tally card 340 and a pencil. NOTE: To expedite play, each player may take three Indicator cards 140 and two Entry cards 120.

5. Select a player as the Banker. The Banker must keep personal funds separate from those of the Bank. All transactions must go through the bank.

6. Each player is given $300, divided as follows: $100 (2), $50 (1), $20 (2), and $10 (1).

### Commencement of Play

1. Each player places a pawn on The Opening Bell 150 space.

2. All players shake one die; the player with the highest roll starts play.

3. To play, each player rolls two dice and moves the pawn the number of spaces (in a clockwise direction) indicated on the dice. (NOTE: Rolling doubles allows the player to retain the dice and roll again.)

4. The player must follow the directions indicated on the game board space on which the pawn lands. If a pawn lands on a Squawk-box space 60, the player reads the card aloud and follows the instructions if pertinent (see below for details).

5. After the first player completes this sequence, the turn passes to the player on the left. (NOTE: Landing on the same space as another player does not affect either player.)

### Playing Pieces

Playing pieces include the following: pawns, card holders, optional square contract chips, the protective stops 90, two white dice, and the yellow or market dice. The pawn defines you as a player. When you roll the dice, you move your pawn the designated number of spaces—the addition of the two rolled dice. The space this piece lands on instructs the player what to do next. The card holder is used to hold the player's Entry 120, Indicator 150, and Contract cards 45. The card holder has two, three or more slots on it. Prior to a player entering a trade, the cards in the close slot face the player. When the player enters a trade, the player gathers the cards being used and places them in the farther slot facing the other players. Five square contract chips 80 if used are dispensed at the beginning of the game to each player, so that each player has 5 colored square contract chips 80 matching the pawn color. The square contract chips 80 represent the number of contracts the player can buy when entering a trade.

To make one (1) contract, the player places the money 70 in front of the card holder and places one (1) square contract chip 80 on top of the money 70. To make five (5) contracts, the player places the money 70 (for five contracts) in front of the card holder and all five (5) contract chips 80 on the money 70. (NOTE: A player may make between one (1) and five (5) contracts when entering a trade.)

The protective stop 90 is designated by the red color and its ‘Stop Sign’ shape. When entering a trade, it is always a wise idea to use the protective stop 90. When the player uses the protective stop 90 and the trade is not successful, either by the dice roll or an unforeseeable turn in the market (discussed later), the player only loses the protective stop 90 money 70 (as designated on the billboard and tally card). If the protective stop 90 is not used and the trade is not successful, either by the dice roll or an unforeseeable turn in the market (discussed later), the player loses ALL of the money 70 in the contract. To use the protective stop 90, place it on top of the square contract chips 80 (if used) and money 70 when entering a trade.

Two white dice are used to generate travel around the board 1. The gold die is used when exiting a trade. Therefore, a total of three dice are used to exit a trade. The market die is used only when entering a trade. When a player is ready to enter a trade, he/she obtains this die and shakes it. The top face shows the market he/she will be entering. If the player does not have enough money 70 for one contract in the said market, he/she may roll the market die until it lands on a market he/she can afford. For example, if a player rolls the market die for his/her first trade, only has $300, and the market die displays US Dollar Index, which costs a total of $300 (margin money+protective stop), the player MUST enter into that market because he/she does have enough money 70 to cover the contract.

The Toolbox 100 is placed on a designated Indicator space 110 on the game board 1, which is designated by the grey shading and the word TOOLBOX. If a player lands on the Toolbox 110, he/she removes it from the board 1. The Toolbox 100 will be used to double the player's profit on a successful trade. If a player is currently in a trade, he/she must use the Toolbox 100 for said trade. If a player is not in a trade, he/she must use the Toolbox 100 for his/her next trade. If a player uses the Toolbox 100 and his/her trade is not successful, he/she only loses the original amount designated (the loss is not doubled). After exiting the trade (either successfully or unsuccessfully), the player places the Toolbox 100 back on the designated space. When the Toolbox 100 is in the control of a player, the Indicator space where the Toolbox normally rests 110 is treated as a regular Indicator square115.

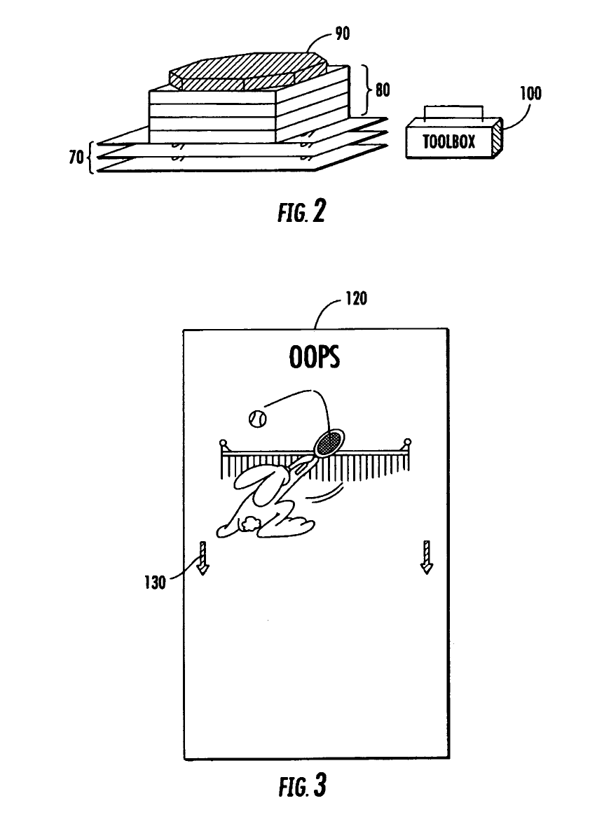

When a player enters a trade, he/she stacks the money 70, Contract Chip(s) 80 if used, Protective Stop 90 (if used), and anything else he/she wishes to use in front of his/her card holder. Please refer to FIG. 2 for proper stacking.

### Cards

Entry cards 120 are designated by their green color. The green rectangle on the game board 1 designates the placement of the Entry cards 20. There are a total of four (4) Entry techniques: MOCK TURTLE, 18 BAR ENTRY, QUALIFIED TREND LINE, OOPS. Each technique has a designation (arrow) 130 to indicate the market going up or down. This allows for a total of eight (8) types of entry. When entering a trade, your Entry direction 130 must match your Indicator direction 150. Only one (1) Entry technique may be used when entering a trade. Each Entry technique holds the same value—one is not better than the other. Please refer to FIG. 2. After exiting the trade (either successfully or unsuccessfully) the player places the used Entry card 120 back on the bottom of the Entry card pile.

Indicator cards 140 are designated by their yellow color. The yellow rectangle on the game board 1 designates the placement of the Indicator cards 140. There are a total of twelve (12) groups of Indicators: Sentiment, Pinch Or Paunch, Commercials Index, Commercials Net, Open Interest, Progo, Valuation, Seasonal, Premium, Adx, Percent R, Wild Card Best Pick (Picture Perfect). Each Indicator Card has a designation (arrow) 150 to indicate the market going up or down. This allows for a total of 37 different Indicators.
OPEN INTEREST has two sub-categories, Commercials and Large Specs, these sub-categories are still counted as one group of Indicators.
SEASONAL has two sub-categories, Following the Trend and Not Following the Trend, these sub-categories are still counted as one group of Indicators.
TWO-INDICATORS cards have two different groups of indicators on the same card.
PREMIUM cards designate a specific market of several provided in the game. For example, the game can be provided with a group of commodities, such as Wheat, Lean Hogs, T-Bonds, US $ Index, Gold or S & P. Another preferred group includes US $ Index, T-bonds, Wheat, Orange Juice, Coffee and Gold. Traded commodities include, but are not limited to, Wheat, Corn, Soybeans, Soybean Oil, Soybean Meal, Oats, Rough Rice, Cocoa, Coffee, Cotton, Sugar Lean Hogs, Pork Bellies, Live Cattle, Feeder Cattle, WTI crude, Light Sweet Crude, Brent Crude, Natural Gas, Heating Oil, Gulf Coast Gasoline, Propane, Uranium, Gold, Platinum, Palladium, Silver, Copper, Lead, Zinc, Tin, Aluminium,Nickel, Aluminium Alloy, Recycled Steel, rare metals, Ethanol, Rubber, Palm Oil, Wool, Polypropylene, Linear Low Density Polyethylene) that must be entered when using the card. These designations are only on the PREMIUM cards when the Front Month is Higher. In a preferred embodiment, the PREMIUM cards designate only coffee.
ADX cards (Picture Perfect) and WILD CARD-BEST PICK cards represent the market going up or down—the player gets to choose the direction.

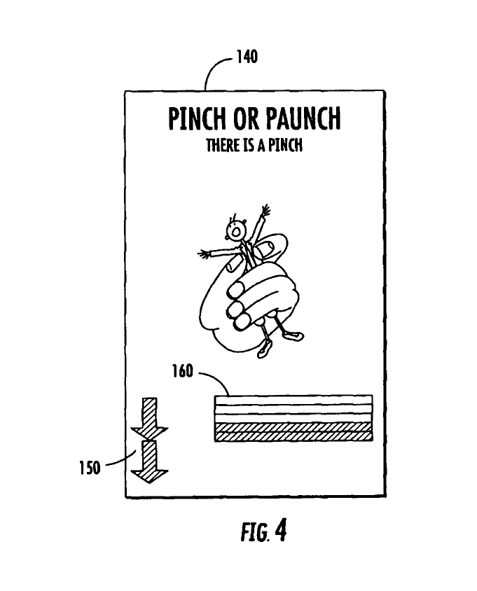

To enter a trade, your Indicator card direction 150 must match your Entry card direction 130. Only one Indicator card 140 from each Indicator group may be used when entering a trade. Two (2) or more Indicator cards 140 must be used in order to enter a trade. Each Indicator card 140 has a weight of zero (0) to four (4). The weight 160 can be found by adding the number of shaded boxes, which are stacked on top of each other. TWO-INDICATOR cards 140 have two weights 160 on them; add both weights 160 to find the weight 160 of the Indicator card 140. The sum of the weights 160 of the Indicator cards 140 used to enter a trade is the Indicator Total 320 (discussed later). The higher the sum of the indicators, the more favorable (less risky) is the trade. Please refer to FIG. 3. After exiting the trade (either successfully or unsuccessfully) the player places the Indicator cards back 140 on the bottom of the Indicator card pile.

Squawk box cards 35 are designated by their orange color. The orange rectangle on the game board designates the placement of the Squawk box cards 30. Squawk box card categories are Textbook Teachings and Market News. On receipt of a Textbook Teachings card, the player either pays or receives money 70. If the player pays money 70, he/she pays the money 70 to the Bank. If agreed by the players, he/she may place the money 70 owed into the board center 170 rather than the Bank. With Market News, the card tells what the different markets are doing. Every player who is in a trade is affected by the Market News, no matter who draws the Squawk box card 35.

### EXAMPLE 1

If an initial player is trading Wheat and expects the market to go up, and another player lands on the Squawk box space 60 and draws a card stating that Wheat is going up, the initial player is safe.

### EXAMPLE 2

If an initial player is trading Wheat and expecting the market to go down, and another player lands on the Squawk box space 60 and draws a Squawk box card 35 stating that Wheat is going up, the initial player must get out of the market and lose money (NOTE: If the initial player was using the protective stop, he/she only loses the protective stop 90 money 70).

Contract cards 45 are designated by their blue color. The blue rectangle on the game board 1 designates the placement of the CONTRACT cards 40. Contract cards 45 are also designated on the game board 1 by a blue space that states CONTRACT CARD ORANGE BILL 180. There are two (2) groups of Contract cards 45: Bump & Run and Kiss & Collapse. The Bump & Run Contract card indicates the market is going to go up. The Kiss & Collapse Contract card indicates the market is going to go down. The Contract card's designation (arrow) must match the Indicator cards 150 and Entry card 130. A player can only use a Contract card 45 when he/she is already in a trade where he/she has five (5) contracts. The Contract card 45 allows the player to add one (1) to five (5) extra contract(s) to his/her existing contracts, as long as he/she has enough money 70 to cover the additional contracts. The player is able to add the additional contracts using the Contract card 45 after he/she is in a trade and passes over the EXIT TECHNIQUE: THREE BAR TRAILING STOP 250 game space. Only one Contract card 45 may be added each time the player passes over the EXIT TECHNIQUE: THREE BAR TRAILING STOP game space 250. After adding a Contract card 45 the player must travel around the board 1 and pass over, or stop on, an Exit Technique to exit his/her trade 250, 260. Players are allowed to hold on to their Contract card(s) 45 until they use them. After exiting the trade (either successfully or unsuccessfully) the player places the Contract card 45 under the Contract card pile 40.

### Spaces

The Opening Bell 150 is the starting position of the pawns. Each person places a pawn on The Opening Bell 150 the beginning of the game. After rolling two die, players move clockwise around the board 1. The arrow coming off The Opening Bell space 190 designate the first space the players move on to.

Entry spaces 200 are designated on the board 1 in green. Entry spaces 200 share specific Indicator (yellow) spaces 115. The player who lands on an Entry space 200 has the choice of an Entry card 35 or an Indicator card 140. If the player chooses the Entry space 200, he/she picks up an Entry card 35 from the Entry card pile 20. The player who lands on Entry×2 space 205 gets two Entry cards 35 from the entry card pile 20.

Indicator spaces 115 are designated on the board 1 in yellow. When a player lands on an Indicator space 115 he/she picks up an Indicator card 140 from the Indicator card pile 110. One Indicator space says “INDICATOR×2” 210 and allows the player to pick up two Indicator cards 140. One Indicator space says “INDICATOR×3” 220 and allows the player to pick up three Indicator cards 140. Some Indicator spaces 115 share Entry (green) spaces 200. The player who lands on those specific Indicator spaces 115 has the choice between an Indicator card 140 and an Entry card 35. If the player chooses the Indicator space 115, he/she pick up an Indicator card 140 from the Indicator card pile 110.

Squawk-box spaces 60 are designated on the board 1 with a microphone in the middle. When a player lands on a squawk-box space 60, he/she picks up a squawk-box card 35 from the squawk-box card pile 30.

Vacation space 230 is designated on the board 1 in blue with a palm tree, sun, and water in the background. If a player lands on the On-Vacation space 230 and he/she is in a trade, he/she loses two (2) turns. If a player lands on the On-Vacation space 230 and he/she is not in a trade, he/she moves ahead to the next space (the player then has a choice between an Indicator 115 or an Entry 200). A player On Vacation 230 is still affected by Squawk box cards 35 that other players draw.

There is one You Ran A Marathon For Charity space 240 designated on the board 1 in blue with a person, sun, and grass in the background. If decided upon at the start, a player landing on the You Ran A Marathon For Charity space 240 collects the money 70 (if any) in the board center 170. If a player is in a trade he/she is still affected by Squawk box cards 35 that other player's draw.

### Exit Technique

The Three Bar Trailing Stop space 250 is designated on the board 1 in red with a stop sign in the background. The Three Bar Trailing Stop space 250 has an exit weight (discussed later) of one (1). A player in a trade can exit the trade by landing on or passing over this space. To exit the trade, a player announces that he/she will be doing so and rolls three die (the two white dice and the gold die). The player adds the value of the three dice together. To have a successful trade, the addition of the three dice must be greater than or equal to the Target Dice Roll, which is located on the Billboard Plaque 265 (discussed later).

The Target Shooter space 260 is designated on the board 1 in red with a target in the background. The Target Shooter space 260 has an exit weight (discussed later) of three (3). If a player is in a trade, he/she is able to exit the trade by landing on this space. To exit the trade, the player rolls three die (the two white die and the gold dice). The player adds the value of the three die together. To have a successful trade, the addition of the three die must be greater than or equal to the Target Dice Roll 380, which is located on the Billboard Plaque 265 (discussed later).

The Contract Card Or Orange Bill 180 is designated on the board 1 in blue with fireworks in the background. If a player lands on this space he/she has a choice of $50 from the bank or drawing a Contract Card 45.

The center of the board 170 can have various uses. When a player finishes his/her five (5) trades, he/she places his/her pawn in the center. If decided, the game may be played with the rules that if a player draws a Squawk box card 35 and has to pay money 70, the center 170 is where his/her money 70 goes. When a player lands on the You Ran A Marathon For Charity space 240, he/she collects the money 70 that has accumulated in the board center 170.

### Forms

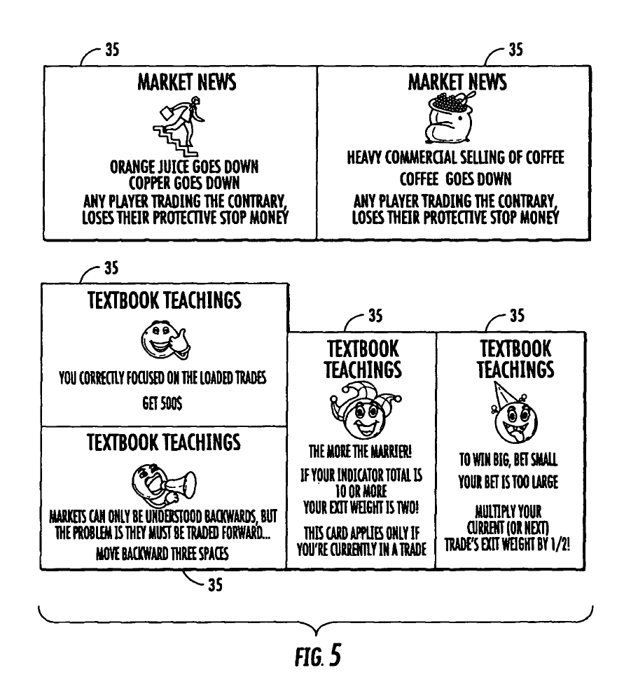

The Billboard Plaque 265 should be located somewhere on the playing surface so everyone is able to easily see the numbers. Please refer to FIG. 4. The Billboard Plaque 265 shows all six (6) markets, their Margin Money, Protective Stop Money, Total cost, different Contract Costs (one (1) through five (5)), the Indicator Total, and Target Die Roll, or Higher 270. These numbers are used by each player when filling out the Tally Card 340.

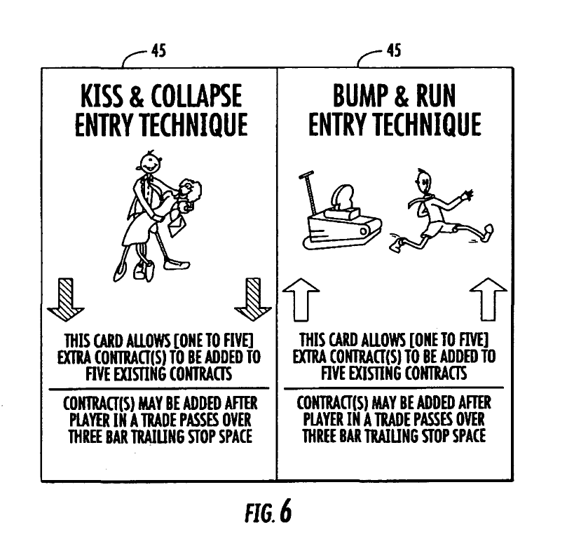

Each player has a Tally card 340, which is used to keep track of trades that were made (successfully or unsuccessfully). After completing five (5) trades, the player places the pawn in the board center 170. Please refer to FIG. 5.

TABLE 1
FILLING OUT THE TALLY CARD

| Card Column | Player Action |
|---|---|
| Trader's Name 350 | Enter the player's name. |
| Up or Down 360 | Draw an up or down arrow that shows the direction of the |
| | arrows on the Entry 120 and Indicators cards 140 (shows |
| | the direction the player believes the market is going to go). |
| Indicator Total 370 | Enter the Indicator Total by adding the weights 160 of each |
| | Indicator used to enter into a trade. |
| Target Dice Roll, or Higher 380 | From the Billboard Plaque 265, find the Indicator Total |
| | 320, and its corresponding “Target Dice Roll, or Higher” |
| | category. Enter this number that needs to be achieved or |
| | exceeded to have a successful trade. |
| Gold Boxes 390 | Shake the Market Dice prior to entering a trade. The market |
| | that faces up (as long as the player can afford it) is the trade |
| | the player will enter into. Place an ‘X’ in the box that |
| | indicates the trade. |
| Margin Money per Contract 400 | Enter the Margin Money for each market from the |
| | Billboard Plaque 265. The Margin Money is equal to the |
| | Total money 70 needed to enter a contract minus the |
| | Protective Stop money 460. Note that the Margin Money |
| | represents only one (1) contract - regardless of how |
| | many contracts the player is entering. |
| Total Number of Contracts 410 | Enter one (1) to five (5) contracts, depending on how many |
| | are chosen when entering a trade (although there are |
| | exceptions - refer to the Contract Card section). The player |
| | must have enough money 70 to cover the total cost of the |
| | contract(s) (Protective Stop money + Margin Money). |
| Expected Profit for this Trade 420 | Multiply the Margin Money by the Number of Contracts. |
| | Enter this number as the Expected Profit for this Trade. |
| Exit Weight 430 | After the player properly lands on or passes the proper |
| | EXIT TECHNIQUE spaces, the exit weight is entered: The |
| | THREE BAR TRAILING STOP is worth one (1) for an |
| | exit weight. The TARGET SHOOTER is worth three (3) |
| | for an exit weight. |
| Actual Trade Result 440 | Enter the Actual Trade Result by multiplying the Expected |
| | Profit for this Trade 420 and the Exit Weight 430. This is |
| | the total amount that the Bank pays the player for a |
| | successful trade. The Actual Trade Result for an |
| | unsuccessful trade is the amount written in the Protective |
| | Stop Money space 460. |
| Running Balance 450 | Keep a running balance of total trades made. Players start |
| | with a zero (0) balance at the beginning of the game. |
| Protective Stop Money 460 | Enter the Protective Stop Money for each market from the |
| | Billboard Plaque 265. The Protective Stop Money equals |
| | the Total money 70 needed to enter a contract minus the |
| | Margin Money 280. |

In another embodiment, there are provided different rules, more money 70, and special contract cards 520 to afford trading greater numbers of contracts, a different billboard plaque 500 with higher limits, and tally cards 510 allowing the recording of more trades. In this variation there is a monetary goal to reach, for example, a million dollars. In this embodiment, there are seven denominations of money 70: $100; $500; $1,000; $5,000; $10,000; $50,000; and $100,000. In this embodiment, when a player lands on the Contract Card or Orange Bill space 180, the player had a choice of $5000 or a Contract card 45. At the start of the game, the banker distributes to each player $30,000. Differences from the first embodiment include a black Market Dice which is used to determine which of the six markets is entered with the contract: T-bonds, coffee, crude oil, Dow Jones Index, copper or S&P500. The Contract dice is used to determine the maximum number of contracts to be purchased. The number rolled on the dice is the maximum number of contracts purchased at the turn. There are five contract numbers on the contract dice: 50, 100, 150, 200 and unlimited. In one embodiment, the number 100 appears on the Contract Dice twice.

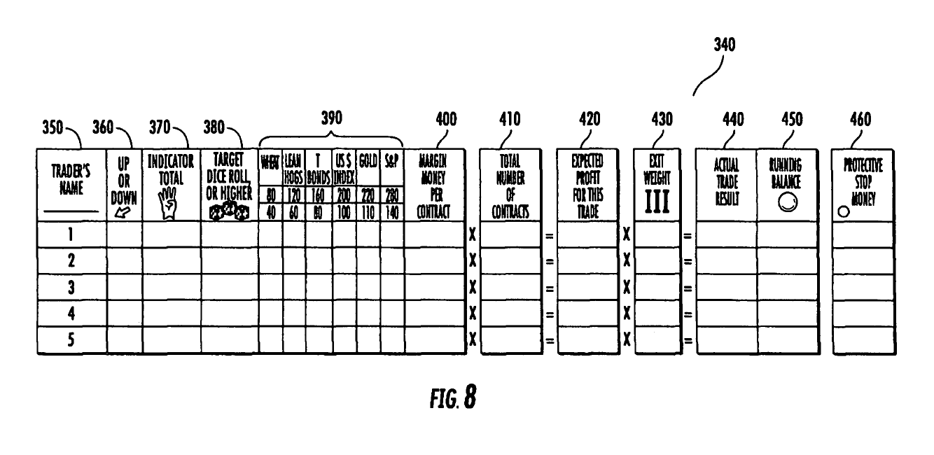

The Million Dollar Challenge Billboard (FIG. 7) should be located on the playing surface so everyone is able to easily see the numbers. The Million Dollar billboard shows all six (6) markets, their margin money, protective stop money, total cost, indicator total, and Target Die Roll or Higher column. These numbers are used by each player when filling out the tally card 510 (discussed next).

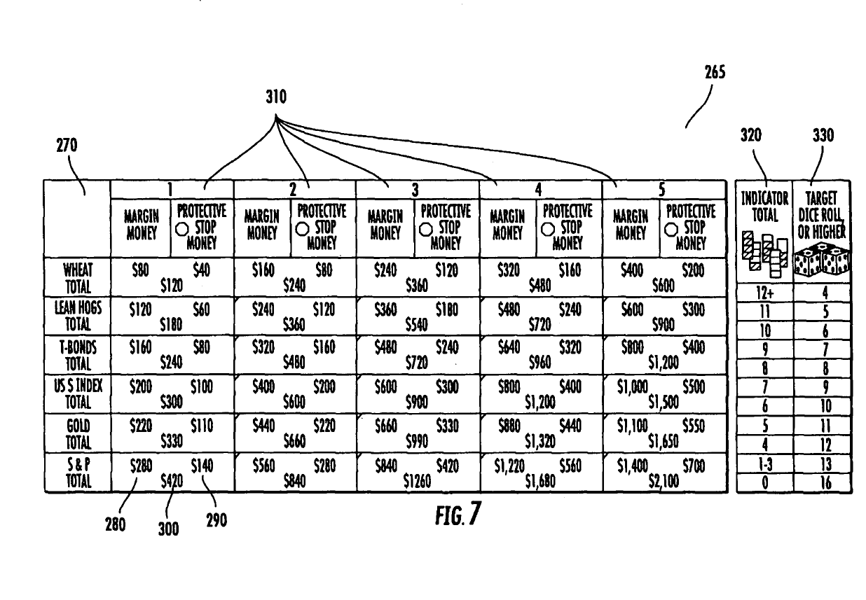

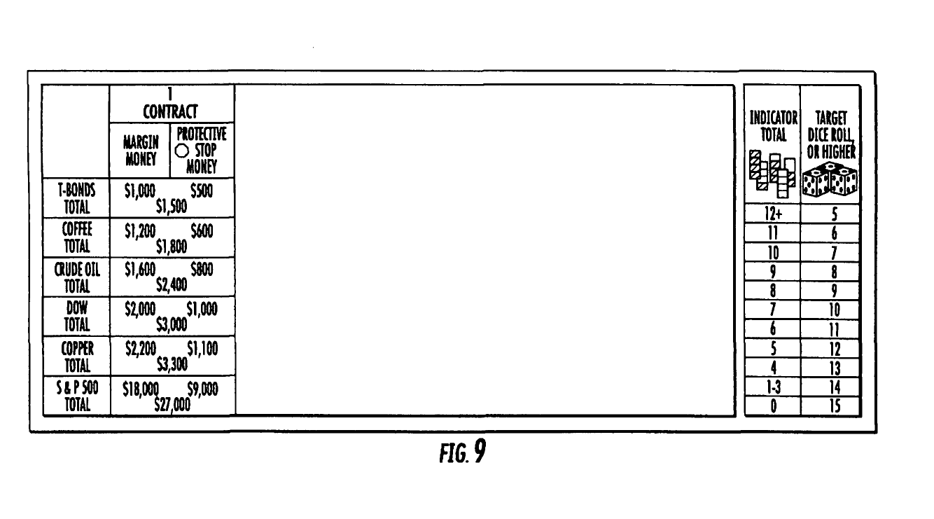

FIG. 8 is the longer Tally card that is used to keep track of trades that were made successfully or unsuccessfully in the race to accumulate a million dollars. It is completed similarly to FIG. 6 discussed above.

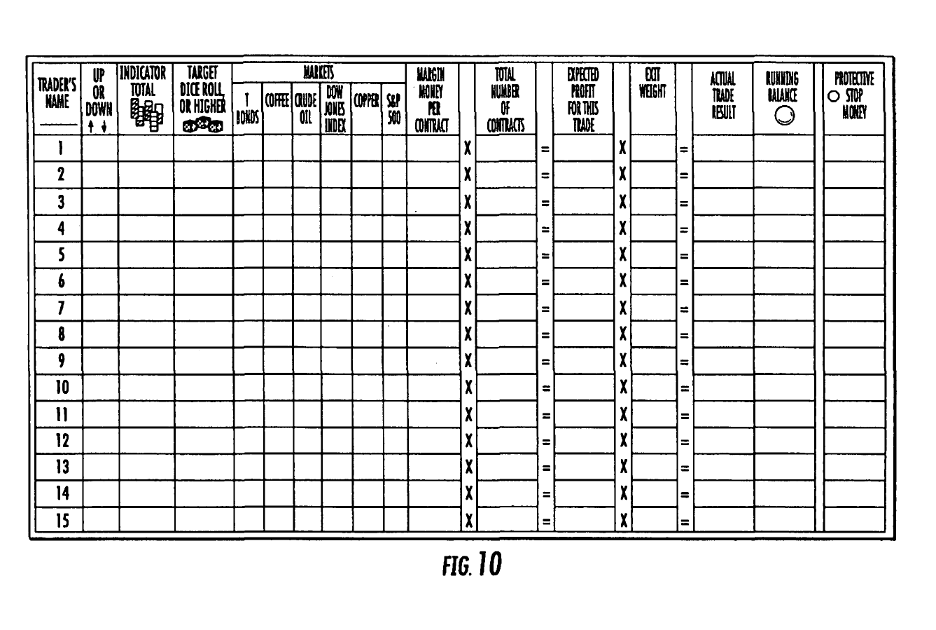

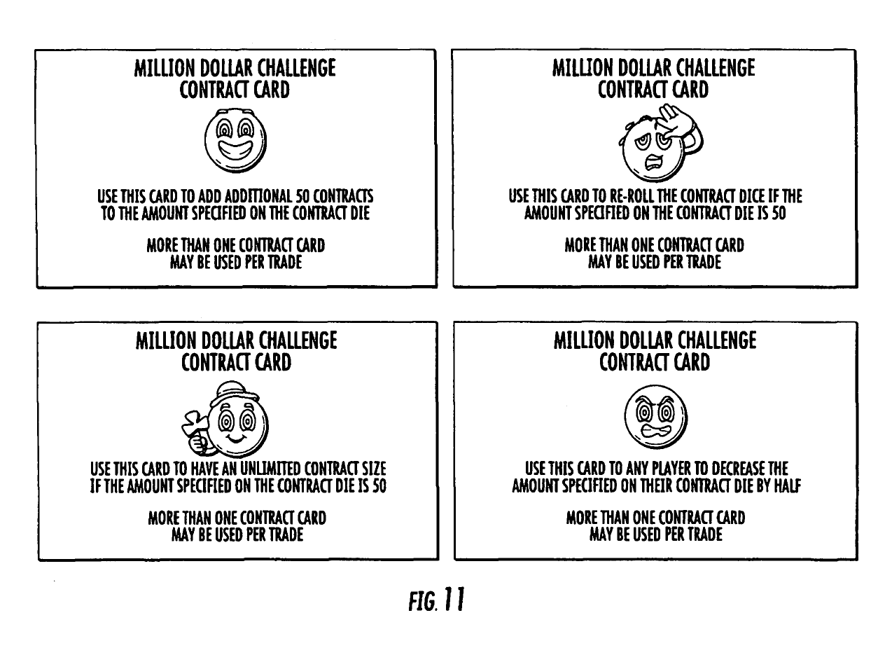

FIG. 9 illustrates examples of Million Dollar Challenge Contract cards which potentially alter limits created by the Contract Dice. The player holds Contract cards until needed. One card can be used to add 50 contracts to the amount on the Contract dice. Another card enables the player to re-roll the contract dice if the dice amount is 50. Yet another card permits the user to have an unlimited contract size if the amount on the contract dice is 50. Yet another card permits the holder to require that another player decrease the amount on their contract dice by half. For all contract cards, more than one card may be used on a trade.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

1. A commodity board game comprising
a. a board comprising
i. a peripheral track marked with spaces for beginning, indicators, advice/payments, entry into contracts, exit techniques, contract, rest or marathon for charity and vacation;
ii. a board center; and
iii. a plurality of places for cards to be drawn, comprising entry, contract, indicator and advice/payments;
b. a plurality of types of cards, comprising
i. entry cards that represent the entry technique and expected market movement;
ii. indicator cards comprising a plurality of different groups, but all showing an up or down arrow and a representation for significance weighting; and
iii. advice/payment cards comprising teachings and market news, the teachings involving receipt or payment of money and market news affecting any player in a trade;
c. at least two numbered dice;
d. a market die comprising six faces, each indicating a different market;
e. a plurality of game pieces for marking a player's progress around the board;
f. a plurality of protective stop chips for a player to lessen a loss;
g. a billboard plaque showing the standard amounts for trades in the different commodities and the parameters for ending trades;
h. a plurality of money of different amounts; and
i. instructions on how to play the game.

2. A method of playing a game of commodities trading, the method comprising
a. providing the board game of claim 1;
b. preparing to play the game by the steps of
i. placing the game board on a flat surface
ii. shuffling the four piles of cards, comprising indicator, entry technique, advice/payments, and contract cards;
iii. selecting a game piece for each player and obtaining one protective stop chip and optionally the five contract chips of the same color;
iv. optionally giving each player three indicator cards and two entry cards;
v. selecting a player as the banker to conduct all transactions; and
vi. giving each player a plurality of money;
c. beginning the game with the steps of
i. placing all game pieces on the opening bell space;
ii. selecting the first player to start, optionally by taking turns shaking and rolling a single die to select the first player with the highest score;
iii. rolling two dice and moving the game piece the number of spaced indicated on the dice;
iv. following the directions on the game board space; and
v. letting the subsequent player(s) take turns;
d. playing the game with the steps of
i. landing on an entry/indicator space and choosing one or the other;
ii. if choosing the entry, selecting an entry card;
iii. if choosing the indicator, selecting an indicator card;
iv. accumulating entry and/or indicator cards until deciding to buy a commodity;
v. landing on an advice/payment space and picking up an advice/payment card and following the directions;
vi. landing on the vacation space with the results comprising
1. losing two turns if in a trade; or
2. if not in a trade, moving to the next space with a choice between an indicator or an entry;
vii. landing on the Marathon for Charity space and collecting money in the board center if available;
e. making a trade in commodities with the steps of
i. accumulating cards comprising
1. at least two indicator cards having the arrows in the same direction and being of different groups;
2. at least one entry card with an arrow in the same direction as the indicator cards;
ii. landing on an entry space;
iii. adding the weights of the indicator cards;
iv. obtaining and rolling the market die to determine the market in which to make the trade;
v. determining the cost of the trade from a graph showing the cost of the margin money and optionally the protective stop and whether the player has enough money for the trade and if not, re-rolling the die until selecting a market the player can afford;
vi. if having enough money for the contract, determining if the player can enter multiple contracts, each requiring a contract chip if used;
vii. putting the money, contract chips if used and optionally the stop in one stack on the board;
viii. calculating the expected profit by multiplying the margin money by the number of contracts; and
ix. turning the cards of the trade toward the board;
f. closing a trade in commodities comprising the steps of
i. landing on or passing over an exit space and determining a weighting value thereof;
ii. rolling a plurality of dice;
iii. calculating the dice total;
iv. determining if the dice total is equal or greater than a target number, the target number being less when the player has more indicators in the trade and the target number being more when the player has fewer indicators in the trade, thereby providing less risk when there are more indicators supporting the trade;
v. if the dice total is less than the target number and if the protective stop was used, paying to the bank the amount of the protective stop money;
vi. if the dice total is less than the target number and if no protective stop was used, multiplying the expected profit by the weight of the exit space to determine total loss on the trade and paying to the bank the total loss;
vii. if the dice total is equal to or greater than the target number,
1. multiplying the expected profit by the weight of the exit space to determine total profit on the trade; and
2. having the bank pay the total profit; and
viii. placing the indicator and entry cards under their respective card stacks on the board.
